(19) United States
(12) Patent Application Publication
(10) Pub. No.: US 2016/0214239 A1
(43) Pub. Date: Jul. 28, 2016

(54) SCREWDRIVER WITH ROTARY UNIT FOR CHANGING BITS

(71) Applicant: Zheng-Cong Jiang, Taichung City (TW)

(72) Inventor: Zheng-Cong Jiang, Taichung City (TW)

(21) Appl. No.: 14/602,276

(22) Filed: Jan. 22, 2015

(51) Int. Cl. B25B 23/00; B25B 15/04; B25G 1/08

(52) U.S. Cl. CPC B25B 23/0035; B25G 1/085; B25B 15/04

(57) ABSTRACT

A screwdriver includes a main part having a connection section, a reception section and an insertion section. A rotary unit is located in the reception section and has a base and a rotary member which has multipole holes and is rotatably located in the base. An end member is connected to the connection section and has a polygonal-hole section and a circular-hole section. A handle is mounted to the insertion section and has a push rod which extends through the main part, the rotary unit and the end member. The push rod has a magnetic connected to the distal end thereof The desired bit can be pushed to the end member by the push rod. The rotary member is replaceable for being cooperated with different types of bits.

### BACKGROUND OF THE INVENTION

1. Fields of the Invention

The present invention relates to a screwdriver, and more particularly, to a screwdriver having a rotary unit for quickly changing bits.

2. Descriptions of Related Art

The conventional hand tool such as the screwdriver usually has only one specific function end which is used to be engaged with a specific bolt. In other words, if the bolts have different types of heads, different screwdrivers are needed. However, the screwdrivers are heavy and occupy a lot space.

There are some screwdrivers which are designed to be used with different types of bits. Nevertheless, the bits have to be carried and/or stored separately. The user then picks the desired bit when needed, and this is not convenient for the user to carry and store the bits.

Another screwdriver includes a rotary unit which accepts multiple bits, and the handle of the screwdriver has a push rod which pushes the bit to the front end of the screwdriver. However, the bits are received in the slots of the rotary unit and only a limited number of bits can be stored in the rotary unit. During exchanging the bit, the bit may drop from the rotary unit.

The present invention intends to provide a screwdriver which has a rotary unit for changing the bits, the screwdriver eliminates the shortcomings mentioned above.

### SUMMARY OF THE INVENTION

The present invention relates to a screwdriver and comprises a main part having a connection section, a reception section and an insertion section. The reception section is located between and communicates with the connection section and the insertion section. A rotary unit comprises a base and a rotary member, wherein the base is located in the reception section, and the rotary member has multipole holes and are rotatably located in the base. An end member has a polygonal-hole section and a circular-hole section. The end member is connected to the connection section and communicates with the reception section. A handle has a push rod which extends through the main part, the rotary unit and the end member. The insertion section of the main part is movably inserted into the handle. The push rod has a magnetic connected to the distal end thereof.

Preferably, the push rod extends through the insertion section, the reception section, the base, one of the holes and the circular-hole section.

Preferably, a restriction structure is located between the push rod and the insertion section.

Preferably, the restriction structure includes an annular recess defined in the push rod. The insertion section has a reception recess. A restriction member is located in the reception recess and biases the push rod.

Preferably, the restriction member has an engaging portion and distal ends.

Preferably, the rotary member has multiple grooves which are located alternatively relative to the holes. The base has a resilient plate which has a protrusion formed thereon. The protrusion is resiliently engaged with the grooves.

Preferably, the insertion section has a space defined therein.

Preferably, the rotary unit has a shaft so as to be pivotably connected to the base.

Preferably, the rotary member has a positioning unit which has a resilient member and two positioning members. The rotary member has a reception hole in which the resilient member is located. Two ends of the resilient member bias the two positioning members which are in contact with two ends of the reception hole.

Preferably, a magnetic disk is located on one of the two ends of the reception hole.

Preferably, the rotary member has a positioning unit which has a resilient member, a positioning member and a magnetic disk. The rotary member has a reception hole in which the resilient member is located. Two ends of the resilient member respectively bias the positioning member and the magnetic disk. The positioning member and the magnetic disk are in contact with two ends of the reception hole.

Preferably, the end member has a ratchet member mounted thereto.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the screwdriver of the present invention;

FIG. 2 is a perspective view to show the screwdriver of the present invention;

FIG. 3 is a cross sectional view, taken along line A-A in FIG. 3, wherein the handle is pulled backward;

FIG. 4 is a cross sectional view, taken along line A-A in FIG. 3, wherein the handle is pushed forward;

FIG. 5 is an exploded view to show an alternative embodiment of the screwdriver of the present invention;

FIG. 6 is an exploded view of the second embodiment of the screwdriver of the present invention;

FIG. 7 is a perspective view to show the second embodiment of the screwdriver of the present invention;

FIG. 8 is an exploded view of the third embodiment of the screwdriver of the present invention;

FIG. 9 is a perspective view to show the third embodiment of the screwdriver of the present invention, and

FIG. 10 is another perspective view to show the third embodiment of the screwdriver of the present invention.

### DETAILED DESCRIPTION OF THE PREFERRED EMBODIMENT

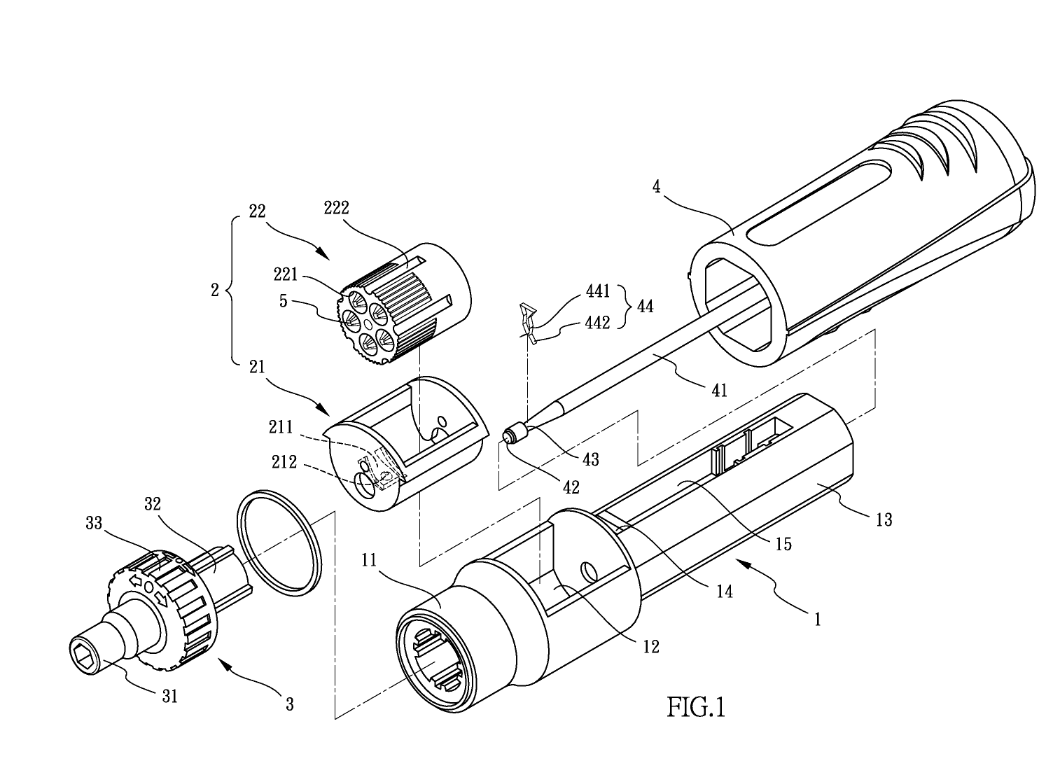

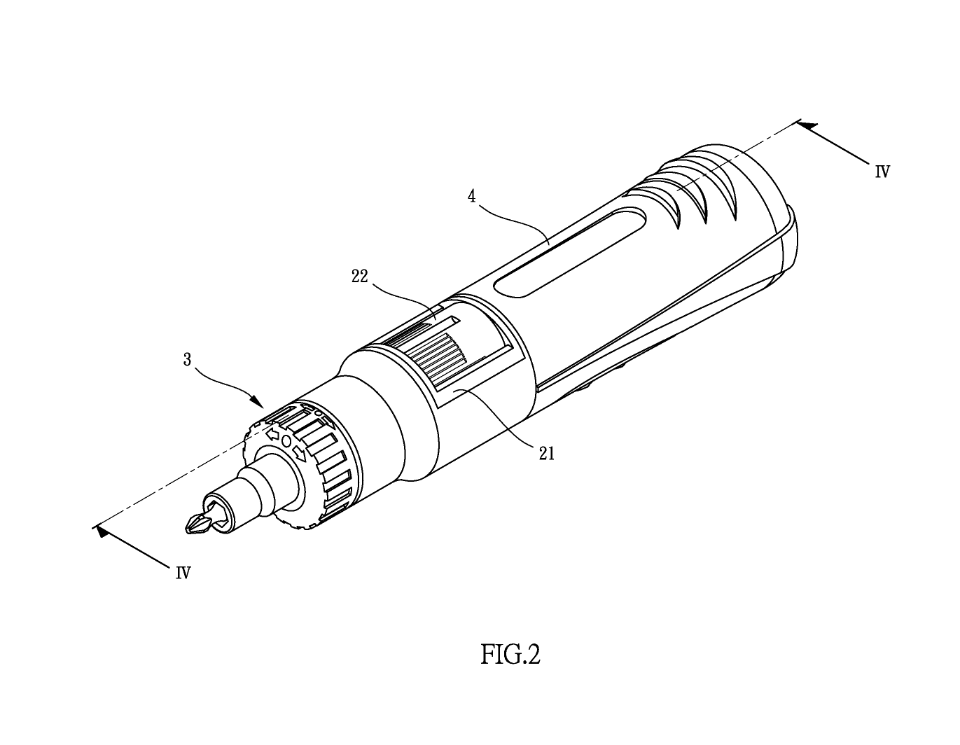

Referring to FIGS. 1 to 4, the screwdriver of the present invention comprises a main part 1 having a connection section 11, a reception section 12 and an insertion section 13. The reception section 12 is located between and communicates with the connection section 11 and the insertion section 13.

A rotary unit 2 comprises a base 21 and a rotary member 22. The base 21 is located in the reception section 12, and the rotary member 22 has multipole holes 221 and is rotatably located in the base 21.

An end member 3 includes a polygonal-hole section 31 and a circular-hole section 32. The end member 3 is connected to the connection section 11 and communicates with the reception section 12.

A handle 4 has a push rod 41 which extends through the main part 1, the rotary unit 2 and the end member 3. The insertion section 13 of the main part 1 is movably inserted into the handle 4. The push rod 41 has a magnetic 42 connected to the distal end thereof The push rod 41 extends through the insertion section 13, the reception section 12, the base 21, one of the holes 221 and the circular-hole section 32.

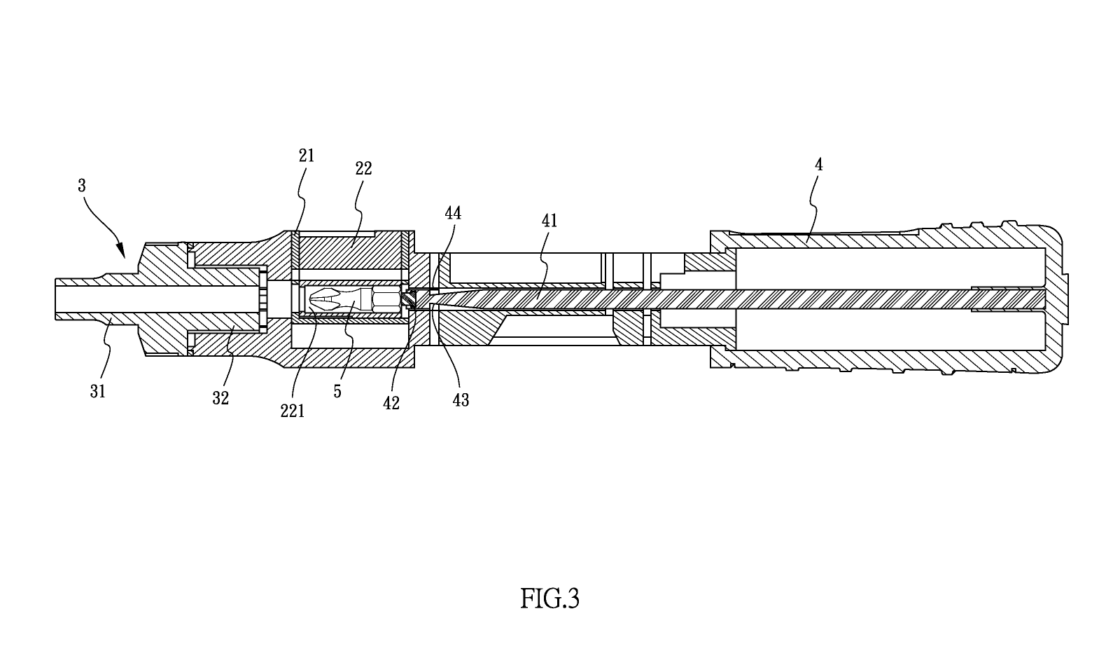

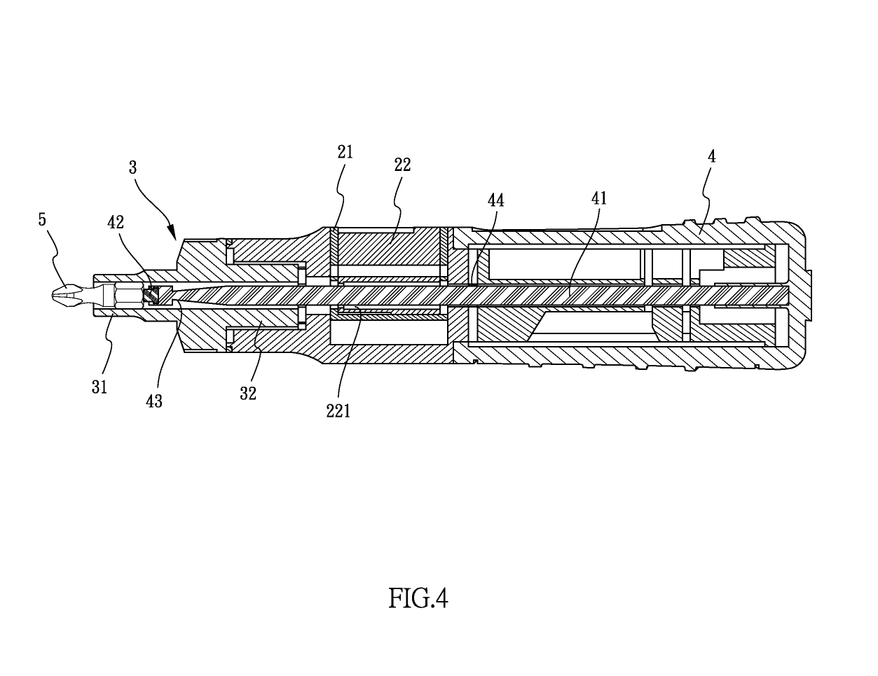

As shown in FIGS. 3 and 4, each of the holes 221 of the rotary member 22 has one bit 5 received therein. When picking one of the bits 5, the handle 4 is pulled backward to remove the push rod 41 from the hole 221, so that the rotary member 22 is freely rotatable. When the desired bit 5 is decided, the push rod 41 is pushed forward, so that the desired bit 5 is pushed through the circular-hole section 32 and the polygonal-hole section 31, such that a portion of the bit 5 protrudes beyond the polygonal-hole section 31, and the rest portion of the bit 5 is engaged with in the polygonal-hole section 31. The bit 5 is supported by the push rod 41 and can output torque to rotate an object. When exchanging the bit 5, the handle 4 is pulled backward and the bit 5 is attracted by the magnet 42 of the push rod 41, so that the bit 5 is moved back to the hole 221 and the push rod 41 is then removed from the hole 221. The rotatary member 22 is rotated to a new position so that the new bit 5 can be pushed by the push rod 41.

The rotary member 22 is directly put in the base 21 without any securing device to position the rotary member 22 so that the rotary member 22 can be removed from the base 21 when the push rod 41 is pulled off from the hole 221. Therefore, another rotary member 22 with different bits 5 can be quickly put in the base 21.

In order to prevent the handle 4 from disengaged from the insertion section 13, a restriction structure is located between the push rod 41 and the insertion section 13. The restriction structure includes an annular recess 43 defined in the push rod 41, wherein the annular recess 43 includes a stop face on the front end and an annular and inclined face on the rear end. The insertion section 13 has a reception recess 14, and a restriction member 44 is located in the reception recess 14 and biases the push rod 41. The restriction member 44 has an engaging portion 441 and distal ends 442. The engaging portion 441 is engaged with the annular recess 43 so as to install the restriction member 44 into the restriction recess 14. When the push rod 41 is pushed forward, the restriction member 44 is expanded outward by the annular and inclined face, so that the push rod 41 is able to move forward. When the push rod 41 is pulled backward, and the engaging portion 441 is engaged with the annular recess 43, the push rod 41 is stopped by the restriction member 44 and cannot be moved backward further, such that the handle 4 cannot be pulled and separated from the insertion section 13 of the main part 1.

In order to position the angular position of the rotary member 22 and to position the hole 221 so that the push rod 41 can push the bit 5 in the hole 221, the rotary member 22 has multiple grooves 222 which are located alternatively relative to the holes 221. The base 21 has a resilient plate 211 which has a protrusion 212 formed thereon. The protrusion 212 is resiliently engaged with the grooves 222 to position the rotary member 22. When the rotary member 22 is rotated again, the rotary member 22 pushes the protrusion 212 away from the groove 222 so that the rotary member 22 is rotated smoothly.

The insertion section 13 has a space 15 defined therein so as to receive an extension rod which has one end extending through the polygonal-hole section 31 and the bit 5 is connected to the distal end of the extension rod to reach the bolt in a deep position. The space 15 may also be used to store other bits or parts.

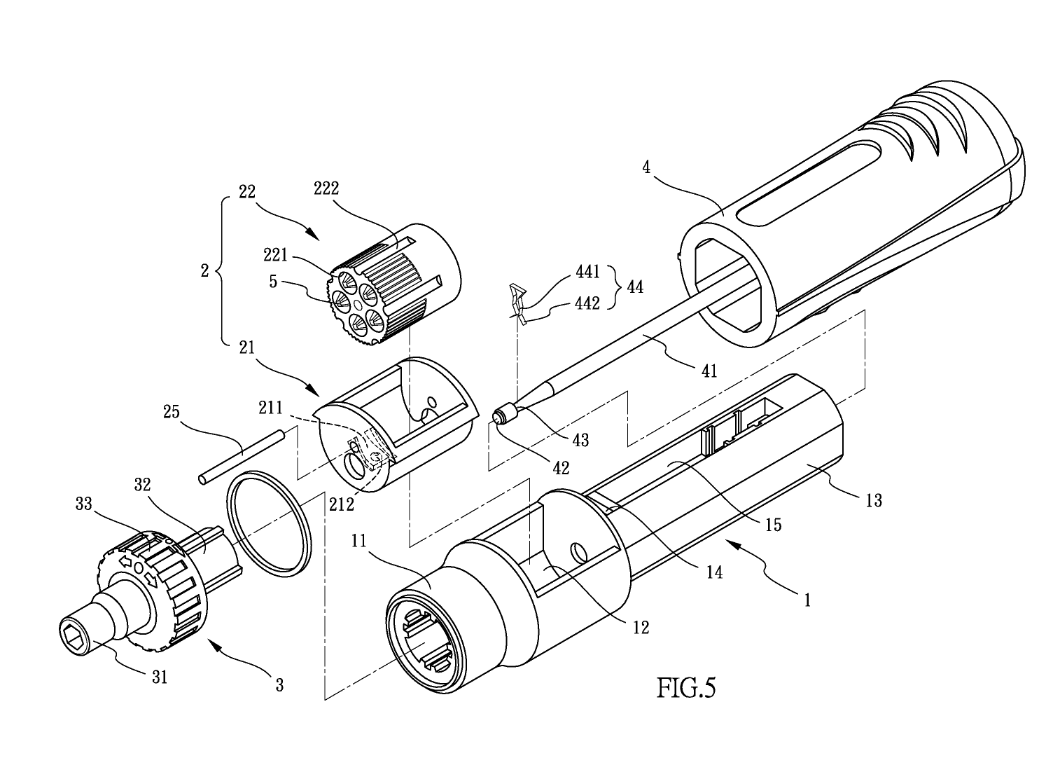

When needed, as shown in FIG. 5, the rotary unit 2 may have a shaft 25 so as to be pivotably connected to the base 21.

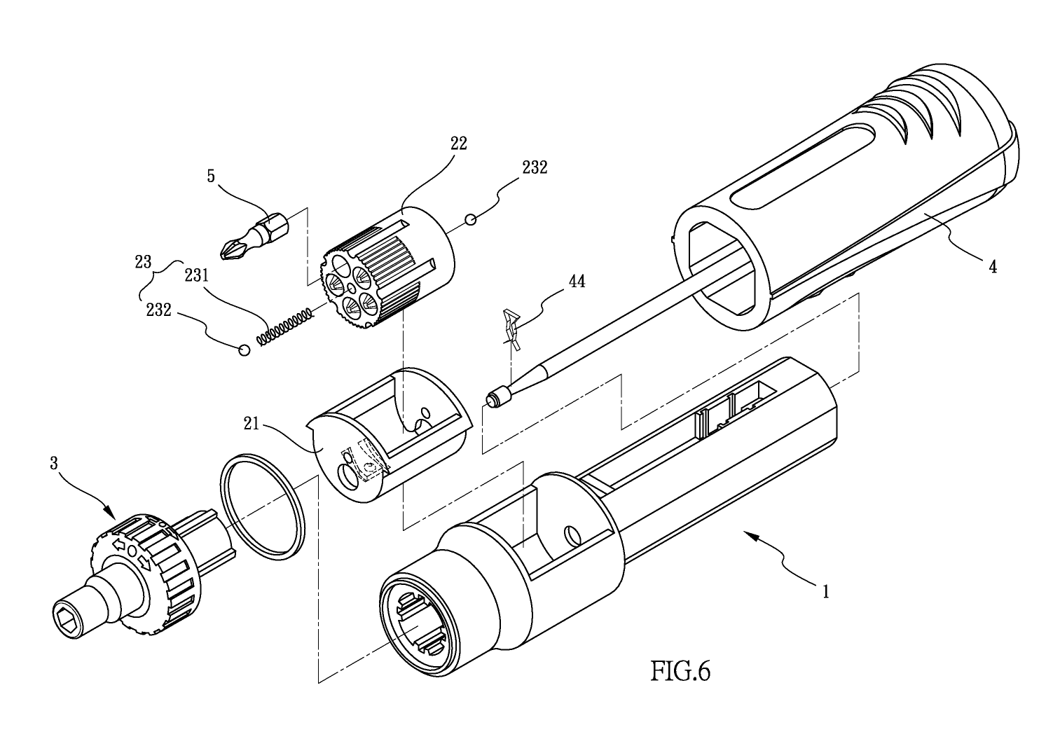

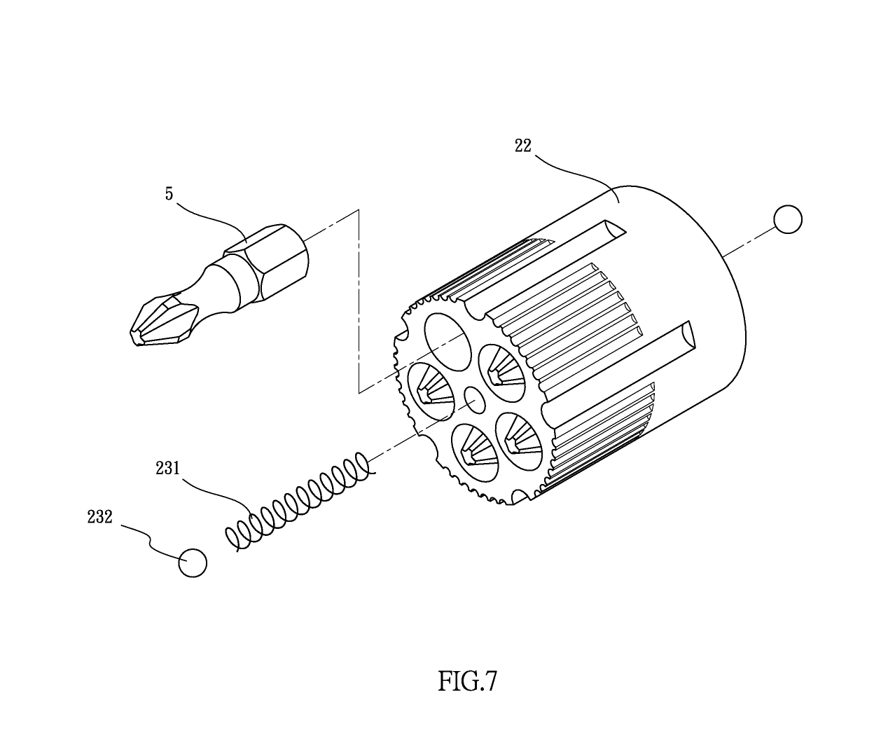

As shown in FIGS. 6 and 7, the second embodiment is disclosed, wherein the difference is that the rotary member 22 has a positioning unit 23 which has a resilient member 231 and two positioning members 232. The rotary member 22 has a reception hole 223 in which the resilient member 231 is located. The two ends of the resilient member 231 bias the two positioning members 232 which are in contact with two ends of the reception hole 223. The rotary member 22 can be smoothly rotated by the shaft and the positioning unit 23. When replacing the rotary member 22, the rotary member 22 is pulled outward, the positioning member 232 are pushed by the insides of the base 21 and compress the resilient member 231 into the reception hole 223, such that the rotary member 22 can be easily replaced.

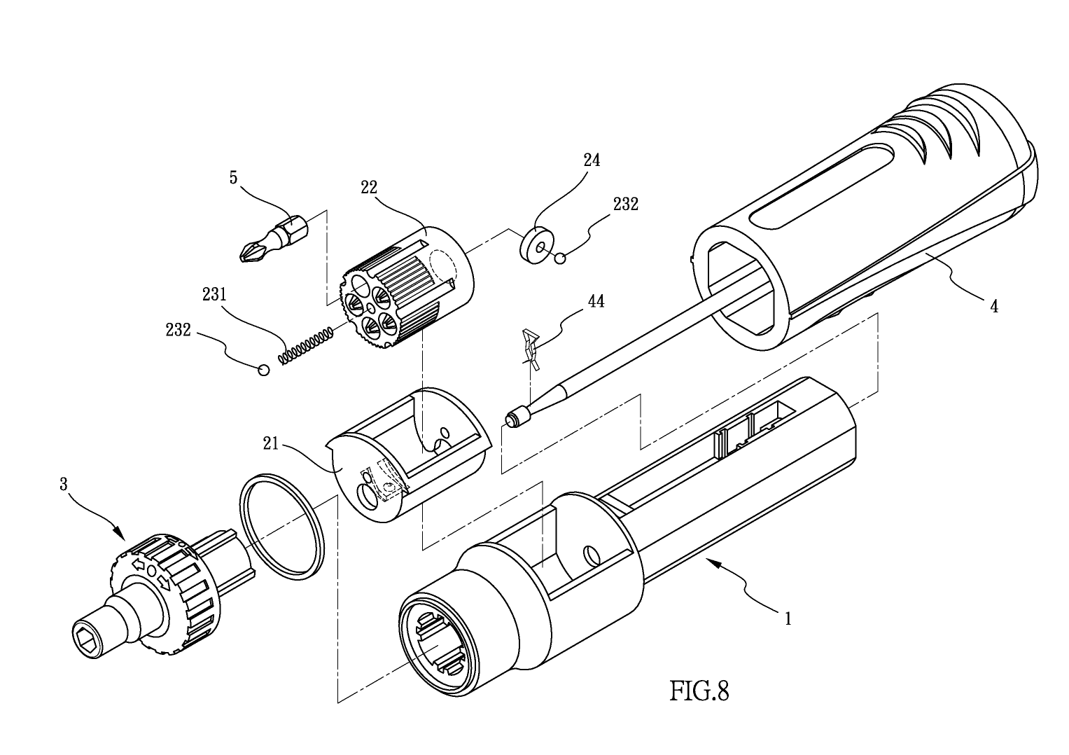

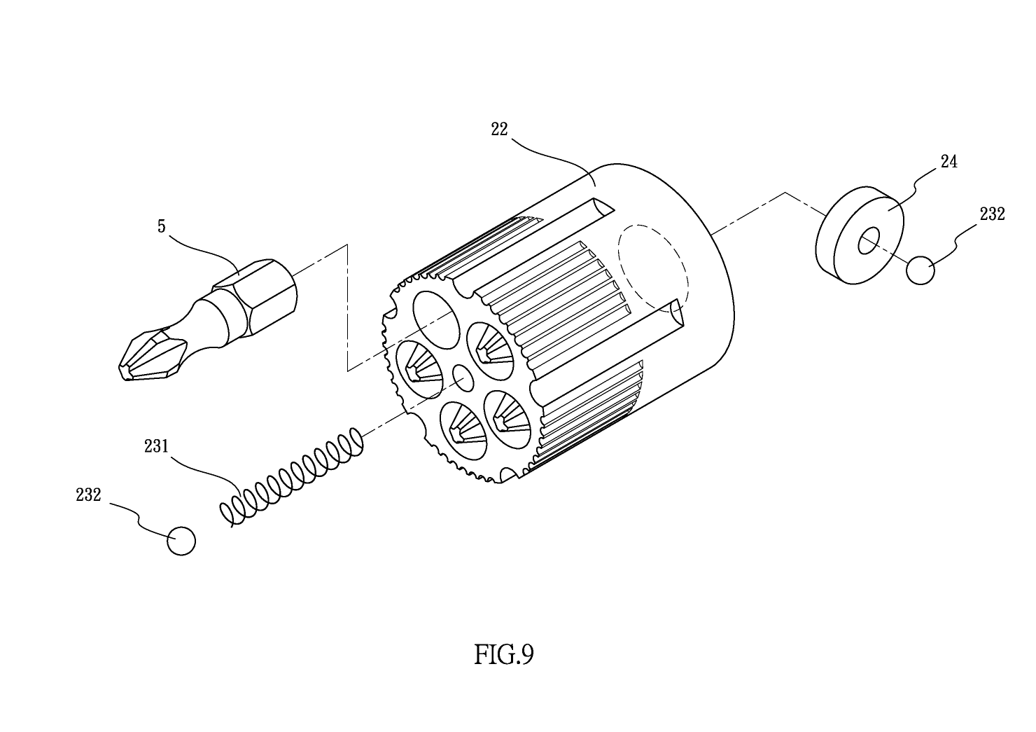

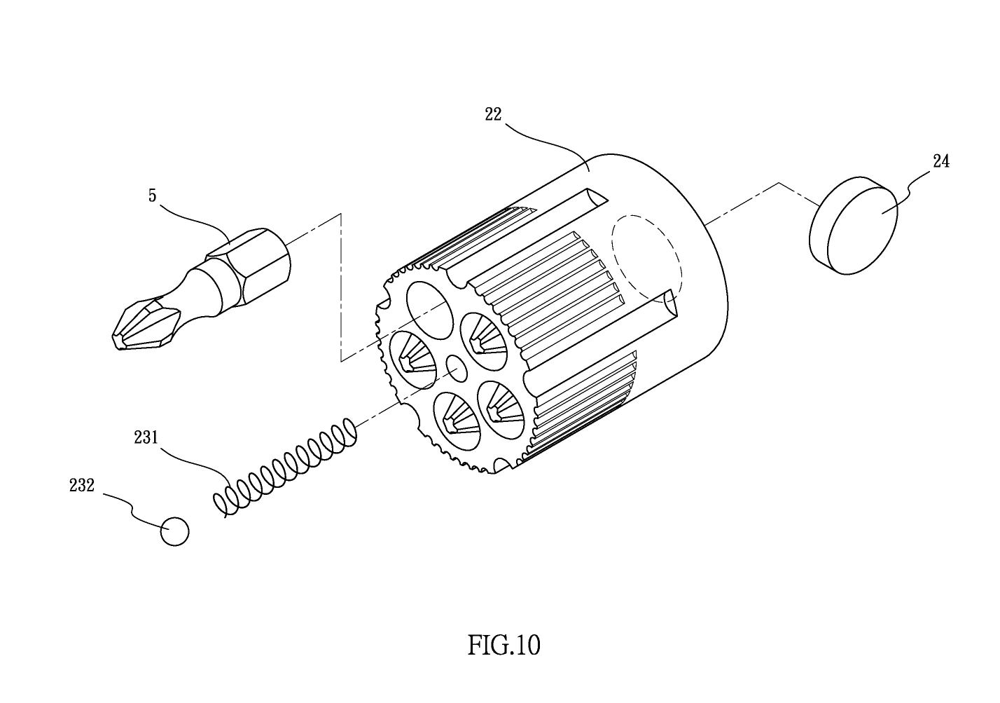

As shown in FIGS. 8 and 9, the third embodiment is disclosed, wherein the difference from the second embodiment is that the rotary member 22 has a positioning unit 23 which has a resilient member 231 as shown in FIG. 10, a positioning member 232 and a magnetic disk 24. The rotary member 22 has a reception hole 223 in which the resilient member 231 is located. The two ends of the resilient member 231 respectively bias the positioning member 232 and the magnetic disk 24. The positioning member 232 and the magnetic disk are in contact with two ends of the reception hole 223. The magnetic disk 24 is located at the rear end of the rotary member 22 so as to attract the bits 5 in the rotary member 22, such that the bits 5 do not drop from the rotary member 22 when the rotary member 22 is tilt.

Besides, the end member 3 has a ratchet member 33 mounted thereto so that the screwdriver performs as a ratchet tool.

While we have shown and described the embodiment in accordance with the present invention, it should be clear to those skilled in the art that further embodiments may be made without departing from the scope of the present invention.

What is claimed is:

1. A screwdriver comprising:
a main part having a connection section, a reception section and an insertion section, the reception section located between and communicating with the connection section and the insertion section;
a rotary unit having a base and a rotary member, the base located in the reception section, the rotary member having multipole holes and being rotatably located in the base;
an end member having a polygonal-hole section and a circular-hole section, the end member connected to the connection section and communicating with the reception section, and
a handle having a push rod which extends through the main part, the rotary unit and the end member, the insertion section of the main part movably inserted into the handle, the push rod having a magnetic connected to a distal end thereof.

2. The screwdriver as claimed in claim 1, wherein the push rod extends through the insertion section, the reception section, the base, one of the holes and the circular-hole section.

3. The screwdriver as claimed in claim 1, wherein a restriction structure is located between the push rod and the insertion section.

4. The screwdriver as claimed in claim 3, wherein the restriction structure includes an annular recess defined in the push rod, the insertion section has a reception recess, a restriction member is located in the reception recess and biases the push rod.

5. The screwdriver as claimed in claim 4, wherein the restriction member has an engaging portion and distal ends.

6. The screwdriver as claimed in claim 5, wherein the rotary member has multiple grooves which are located alternatively relative to the holes, the base has a resilient plate which has a protrusion formed thereon, the protrusion is resiliently engaged with the grooves.

7. The screwdriver as claimed in claim 6, wherein the insertion section has a space defined therein.

8. The screwdriver as claimed in claim 6, wherein the rotary unit has a shaft so as to be pivotably connected to the base.

9. The screwdriver as claimed in claim 6, wherein the rotary member has a positioning unit which has a resilient member and two positioning members, the rotary member has a reception hole in which the resilient member is located, two ends of the resilient member bias the two positioning members which are in contact with two ends of the reception hole.

10. The screwdriver as claimed in claim 9, wherein a magnetic disk is located on one of the two ends of the reception hole.

11. The screwdriver as claimed in claim 6, wherein the rotary member has a positioning unit which has a resilient member, a positioning member and a magnetic disk, the rotary member has a reception hole in which the resilient member is located, two ends of the resilient member respectively bias the positioning member and the magnetic disk, the positioning member and the magnetic disk are in contact with two ends of the reception hole.

12. The screwdriver as claimed in claim 9, wherein the end member has a ratchet member mounted thereto.
